(19) United States
(12) Patent Application Publication
(10) Pub. No.: US 2013/0333670 A1
(43) Pub. Date: Dec. 19, 2013

(54) RECIPROCATING PISTON ENGINE WITH VARIABLE COMPRESSION RATIO

(71) Applicant: DAIMLER AG, Stuttgart (DE)

(72) Inventors: Marc Wodischek, Baltmannsweiler (DE); Simone Nowak, Pluderhausen (DE); Bernd-Heinrich Schmitfranz, Esslingen (DE); Tilmann Römheld, Waiblingen (DE); Michael Wagenplast, Schwaigern (DE); Dieter Nowak, Weilheim (DE)

(73) Assignee: DAIMLER AG, Stuttgart (DE)

(21) Appl. No.: 13/751,024

(22) Filed: Jan. 25, 2013

(30) Foreign Application Priority Data
Jul. 28, 2010 (DE) 10 2010 032 486.8

(51) Int. Cl. F02B 75/04

(52) U.S. Cl. CPC F02B 75/048
USPC 123/48 B

(57) ABSTRACT

In a reciprocating piston engine with a variable compression ratio in which a piston is movably disposed in a cylinder, an adjustment arrangement is provided for controlling the compression ratio of the engine including an adjusting part supported by a guide element depending on a signal provided by a detection means comprising a transducer part arranged on the adjusting part and a corresponding detection part, arranged on a housing part of the engine in connection with a control unit in which a desired momentary compression ratio setting is determined on the basis of a characteristic diagram stored in the control unit.

This is a Continuation-In-Part application of pending international patent application PCT/EP2011/002890 filed Jun. 11, 2011 and claiming the priority of German patent application 10 2010 032 486.8 filed Jul. 28, 2010.

### BACKGROUND OF THE INVENTION

The invention relates to a reciprocating piston engine with a variable compression ratio including a means for detecting the compression ratio of the engine cylinders.

EP 0 520 637 A1 discloses an internal combustion engine with a device for variable adjustment of the compression, wherein the crank pin of the crankshaft is mounted movably in a slot of a pivotable plate. The plate is mounted so that it can pivot about a point fixed in the housing and comprises a further slot, in which the lower end of a connecting rod is also movably mounted. An adjustment of the compression takes place through a displacement of the lower end of the connecting rod in the slot of the pivotable plate. This displacement is brought about by a hydraulic cylinder which is mounted on the one hand fixed to the housing and on the other hand movably at the lower end of the connecting rod.

DE 199 55 250 A1 discloses a method for monitoring the functioning of a device for variable adjustment of the cylinder compression in a reciprocating internal combustion engine. An engine operating parameter which reacts to a change in the cylinder compression is thereby determined before and after a control of the device for changing the cylinder compression. Both values of the engine operating parameter are then compared with each other in order to determine whether a change in the engine operating parameter has occurred, a change in the engine operating parameter being an indicator of correct functioning of the device for variable adjustment of the cylinder compression.

A method is known from WO 01/34948 A1 for controlling the cylinder compression during the start phase of an internal combustion engine which is equipped with a means for changing the compression end pressure. One or more criteria for a difficult start of the engine are checked before a starter of the internal combustion engine is switched on. If at least one criterion for a difficult start is fulfilled, the cylinder compression of at least one cylinder is reduced to a predefined minimum value for so long until the engine speed has been increased to a defined threshold, whereupon the cylinder compression is then increased.

EP 1 431 559 A2 discloses an air intake control means for an engine which comprises a mechanism for variable adjustment of an amount of intake air, said mechanism controlling an amount of fresh air flowing into the engine. Furthermore a mechanism for variable adjustment of a compression ratio is provided which controls a compression ratio of the engine in a variable manner. Sensors detect operating conditions of the engine and the compression ratio, wherein a control means is electronically connected to the sensors to control the mechanism for variable adjustment depending on the amount of intake air, the compression ratio and the operating conditions of the engine.

DE 38 25 369 A1 discloses a means for controlling the compression ratio of an internal combustion engine, with a mechanism for changing the compression ratio of the internal combustion engine, at least between a first higher and a second lower level, corresponding to the engine operating states. Furthermore a compression ratio measuring means is provided for determining the current compression ratio. In addition the means contains a sensor error detection unit for determining malfunctioning of the compression ratio measuring means and a protectine unit for changing and maintaining the compression ratio at the lower level if the sensor error detection means ascertains a malfunction of the compression ratio measuring means.

DE 10 2004 031 288 A1 discloses an internal combustion engine with a characteristic-diagram-controlled variable compression ratio which comprises a load detection unit, a load requirement detection unit and an adjusting member for adjusting the compression ratio. Furthermore an engine controller is provided which is connected to a time signal generator, wherein the engine controller comprises, for determining the variable compression ratio to be set in a region of the internal combustion engine, signal lines for detecting at least a part of the internal combustion engine load. In addition the internal combustion engine comprises a comparator integrated into the engine controller, said comparator determining an optimized compression ratio from the signals transmitted via the signal lines concerning at least the load in comparison with at least values from a pre-definable characteristic diagram.

DE 10 2006 033 062 A1 discloses a method for automatic determination of the present compression ratio of a reciprocating engine in operation, wherein the reciprocating engine has a changeable compression volume and a measurable crank angle, wherein, by means of a component of a piston drive moving relative to a sensor signal is generated and, by means of the signal, a trigger angle in relation to the crank angle is determined, said trigger angle being incorporated into a determination of the present compression ratio.

U.S. Pat. No. 6,857,401 B1 discloses a variable compression ratio sensing system for an internal combustion engine with a crankshaft and at least one piston, wherein the system comprises a connecting rod with a variable compression ratio, via which the piston is connected to the crankshaft. The connecting rod thereby has a plurality of discrete states for adjusting the compression ratio. A digital output sensor for producing a signal is provided, the signal comprising a value corresponding to a determined state of the connecting rod. The sensor is in the form of a Hall sensor which generates a signal whose duration increases with an increasing compression ratio. The Hall sensor signal duration decreases with a decreasing compression ratio.

The known reciprocating engines and methods have potential to adjust a set compression ratio of the reciprocating engine with various degrees of precision.

It is the object of the present invention to provide a a reciprocating engine which facilitates more precise adjustment of the compression ratio.

### SUMMARY OF THE INVENTION

In a reciprocating piston engine with a variable compression ratio in which a piston is movably disposed in a cylinder, an adjustment arrangement is provided for controlling the compression ratio of the engine including an adjusting part supported by a guide element depending on a signal provided by a detection means comprising a transducer part arranged on the adjusting part and a corresponding detection part, arranged on a housing part of the engine in connection with a control unit in which a desired momentary compression ratio setting is determined from the signals as determined by the detection means on the basis of a characteristic diagram stored in the control unit.

The arrangement facilitates, as a result of the detection of the at least one position, in particular at least virtually any position of the adjusting part, a very precise determination of the momentary compression ratio of the corresponding cylinder. In order to determine the compression ratio, further values such as for example lever, distance, and/or angle ratios as well as other trigonometric correlations are considered. In any case, the compression ratio can correspondingly be adjusted precisely.

The determination according to the invention of the compression ratio als facilitates a comparison of the compression ratio set as the actual compression ratio with a desired reference compression ratio to be set. If the actual compression ratio deviates from the reference compression ratio, which may occur for example as a result of wear in case of a very long lifespan of the reciprocating engine, suitable countermeasures can be introduced in order to compensate for this deviation. For example a subsequent adjustment can be carried out so that the adjusted actual compression ratio corresponds at least substantially to the desired reference compression ratio. This results in a very efficient operation of the reciprocating engine with low emissions and low energy consumption, in particular low fuel consumption, even in case of a very long lifespan and a very long operating time.

It is also possible for the detection means to detect a travel distance of the adjusting part between two positions, i.e. a stroke of the adjusting part. This permits the precise determination and thus the precise adjustment, of the compression ratio.

As already indicated, the adjusting part is formed for example as a control piston which comprises a control rod and a piston connected to the control rod, which is arranged so as to be displaceable in a cylinder of the adjusting means which can be impacted with a work medium. The cylinder thereby forms the guide element of the adjusting means. The control piston is configured for example as a hydraulic piston and can be actuated by a hydraulic liquid being supplied to, or removed from, the cylinder, wherein the supply and removal of hydraulic liquid to and from the cylinder is controlled for example by means of an electromagnetic valve.

In contrast to such an active adjustment, a passive adjustment is also possible, wherein the piston is moved due to gas and mass forces of the reciprocating engine which act for example via a piston in the cylinder on the control piston and thus on the piston of the adjusting means. The piston of the adjusting means is released in a desired movement direction and blocked or held securely in the movement direction opposite the desired movement direction, this being achieved through the work medium and valve means, for example non-return valves, which are connected via other control valves, for example a control slide valve with control edges which release or shut off lines for the work medium. There is thus a kind of hydraulic freewheeling. This embodiment has the advantage that a desired compression ratio can be set without additional energy resources and only with very low additional energy resources.

It is also possible for the adjusting part to be in the form of an electromagnet or a part of an electromagnet which is actuated based on the working principle of such an electromagnet for adjusting the compression ratio.

The control piston may be a pneumatic piston which can be actuated by supplying the cylinder thereof with compressed air or releasing compressed air from the cylinder which can be controlled or regulated via an electromagnet.

In any case, the advantage of use of such an electromagnet has the advantage that the adjusting part can thereby be adjusted particularly rapidly and thus the compression ratio can be adapted particularly rapidly and according to requirements to changing operating points or to currently present operating points of the reciprocating engine.

The detection of the position of the adjusting part facilitates checking whether the desired compression ratio is actually set. If this is not the case, subsequent control or regulation is possible until the desired compression ratio is actually set and the adjusting part assumes the position required for this. Factors having a negative impact upon the adaptation of the necessary position by the adjusting part, such as deposits due to wear or similar, can thereby be compensated. In this connection for example the signal characterizing the position is compared with one or more characteristic diagrams stored for example in a regulating or control system of the reciprocating engine and a deviation or exceeding or falling short of a threshold value through such a deviation can be checked.

According to an advantageous embodiment of the invention the detection means comprises at least one transducer part, in particular a magnet and specifically a permanent magnet, and a corresponding detection part, in particular a detection plate, wherein the transducer part is arranged for example on the adjusting part and the detection part on a housing of the reciprocating engine, to which the adjusting part and the guide can be pivoted together relatively about a pivot axis. It is also possible for the detection part to be arranged on the adjusting part and the transducer part on the housing. In other words, during operation of the reciprocating engine, the detection part and the transducer part move relative to each other, as the adjusting means and thus the adjusting part, during operation of the reciprocating engine, carry out movements and move for example with a transverse lever mounted on a crank pin of a crankshaft of the reciprocating engine and move relative to the housing, in particular a crankcase of the reciprocating engine and/or a housing surrounding the adjusting means. This facilitates a particularly precise detection of the position of the adjusting part and consequently a particularly precise adjustment of the compression ratio corresponding to requirements. This leads to an efficient operation of the reciprocating engine with low emissions and low energy consumption.

If the detection means comprises a Hall sensor, to which the detection part and the transducer part are assigned, this has the advantage that the position can thereby be detected particularly precisely and particularly robustly and as a result the compression ratio can be determined and adjusted particularly precisely.

According to a particularly preferred embodiment of the invention the detection part and/or the transducer part are bent, in particular in a convex manner relative to the pivot axis. This avoids or at least reduces a negative impairment of the determination of the compression ratio due to any angle error through the relative movement, in particular the relative pivoting, of the detection part and the transducer part to each other. This is particularly beneficial for the precise detection of the position and thus the particularly precise determination of the compression ratio. A particularly precise determination of the compression ratio is possible when the curvature of the transducer part and/or the detection part corresponds to the pivot movement, wherein for example the center point of the curvature lies on the pivot axis. Angle defects do not thereby arise, or arise only to a very limited extent, in the relative movement of the detection part and the transducer part relative to each other, resulting in a very precise detection of the position of the adjusting part.

It is particularly advantageous for a magnetic field of the transducer part to be curved, in particularly convexly in relation to the pivot axis, whereby preferably the middle point of the curvature lies on the pivot axis and the curvature therefore corresponds to the relative movement, in particular the relative pivoting, of the transducer part and the detection part relative to each other. The position of the adjusting part and hence the compression ratio can thereby be deter mined very precisely so that, by using the determined compression ratio to set a desired compression ratio, this can be set very precisely and in accordance with requirements by means of the adjusting means.

According to a further embodiment the detection means is an optical detection means which comprises a reflection part, in particular a reflection plate. The transducer part of the optical detection means emits beams which are reflected by the reflection part and detected by the detection part. For example in dependence upon the period between the emission of the rays and the detection of the beams reflected by the reflection part by the detection part, the position of the adjusting part can be detected particularly rapidly and precisely and, as a result, the compression ratio can be determined very precisely and also rapidly. This is advantageous particularly insofar as even with rapidly changing operating points of the reciprocating engine and compression ratios to be correspondingly rapidly set and changed, these can be determined and adjusted particularly rapidly. Similarly to the detection part or the transducer part the reflection part is arranged for example on the adjusting part or on the housing, on which the adjusting part or the adjusting means moves at least during the operation of the reciprocating engine.

If the signal is synchronized with a rotational movement of the crankshaft of the reciprocating engine, which is also described as the crankshaft degree ([°KW]), and thus the position or the signal characterizing the position is set relative to the crankshaft degree, the compression ratio is thereby to be determined particularly precisely, as a compression ratio is to be clearly assigned to the detected position of the adjusting part and any ambiguities are avoided. Even in case of the curved emitter part and/or the curved detection part, a signal characterizing the position of the adjusting part can occur, which deviates, even if only slightly, from the actual position of the adjusting part. The detected rotation position (crank angle degree) of the crankshaft clearly characterizes a position on the detection part or the adjusting part, which allows said deviation to be compensated.

This deviation of the detected position from the actual position can for example be determined using tests and be stored for example in a characteristic diagram of a control or regulating system of the reciprocating engine and is thus known so that this error can be compensated in dependence upon the known, because detected, rotation position and the detected position of the adjusting part can be adapted to or aligned with the actual position at least substantially.

A correction value is read for example from the characteristic diagram corresponding to the detected rotation position, by means of which correction value the detected position is corrected. The detection of the position of the adjusting part thereby allows it to be checked whether the position of the adjusting part lies at least substantially within a certain range and the adjusting means or the adjusting part thus has a desired functioning capacity. If the position lies outside of this range this points to a malfunction of the adjusting part so that corresponding countermeasures are to be taken in order to avoid a damaging operation of the reciprocating engine or the adjusting means or an operation of the reciprocating engine with an undesirably high energy consumption and undesirably high emissions. The detection of the position of the adjusting part thus facilitates, in particular, through the described compensation in dependence upon the rotational position of the crankshaft, on the one hand a particularly precise detection of the position and thus a particularly precise setting of the compression ratio and, on the other hand, the checking of the adjusting means or the adjusting part for desired functioning capacity.

A hysteresis compensation is thereby achieved, by which a deviation of the position of the adjusting part from the actual position is compensated. This is particularly advantageous in a region of so-called end stops of the adjusting part. These regions are respective end regions of a movement region, in particular a pivot region, of the adjusting part, in which the adjusting part moves during operation of the reciprocating engine or pivots back and forth about the pivot axis. Particularly large deviations can exist in these end regions. In addition this hysteresis compensation is advantageous if the adjusting part, for setting the maximum or minimum settable compression ratio, has its maximum or minimum stroke and is moved in or out to the maximum. Even in case of such a maximum or minimum stroke, relatively large deviations can be produced. These can be compensated through the hysteresis compensation.

Preferably, the signal characterizing the position is transmitted also in particular to a control or regulating system of the reciprocating engine. Advantageously, a continuous signal transmission with very high scanning rates is provided which benefits the precise detection of the position and thus the precise determination of the compression ratio.

As already described, a particularly precise determination of the compression ratio and thus a particularly precise adjustment thereof is achieved if a deviation of the position of the adjusting part as determined using the signal value of a reference position predefined in a characteristic diagram, in a table or similar is corrected and the position determined using the signal is adapted at least substantially to the actual position. This correction and adaptation can be carried out particularly precisely if the deviation is corrected and adapted in dependence upon a generation of the signal by the detection means and/or a duration of a transmission of the signal to the control or regulating system of the reciprocating engine and/or a duration of signal processing and/or a calculating the performance of the control or regulating system of the reciprocating engine.

Possible interference negatively influencing the signal or the generation and detection thereof can be compensated for by a model-based filtering. Such a model-based filtering ensures that no surreal dynamics of the reciprocating engine or the adjusting means are considered as current values characterizing the reciprocating engine or the adjusting means and thus possibly negatively impair the determination of the compression ratio.

Further advantages, features and details of the invention will become more readily apparent from the following description of preferred exemplary embodiments thereof with reference to the accompanying drawing.

### BRIEF DESCRIPTION OF THE DRAWINGS

FIG. 1 shows in a sectional schematic side view a crank drive for a reciprocating engine with a plurality of cylinders and pistons assigned to the cylinders, whereby by means of the crank drive respective compression ratios of the cylinders can be set cylinder-specifically irrespectively of each other;

FIG. 2 shows a sectional schematic side view of the crank drive according to FIG. 1 with a sketch of the principles for detecting a position of a control piston an adjusting means for adjusting the compression ratio, whereby, using the detected position of the control piston, the adjusted compression ratio of the corresponding cylinder is determined;

FIG. 3 shows a schematic side view of an embodiment of the crank drive according to the preceding figures with a bipolar transducer plate of a detection means of the adjusting means which is curved in the same way as its magnetic field;

FIG. 4 shows the curved transducer plate and its curved magnetic field according to FIG. 3;

FIG. 5 shows a schematic view of a progression of the curved magnetic field of the transducer plate according to FIG. 3 during movement of the adjusting means and a schematic view of a straight magnetic field of such a movement of the adjusting means; and

FIG. 6 is an illustration showing the principles for a compensation of a deviation of a position of the adjusting means from an actual position of the adjusting means detected by the emitter plate according to FIG. 3.

### DESCRIPTION OF A PARTICULAR EMBODIMENT

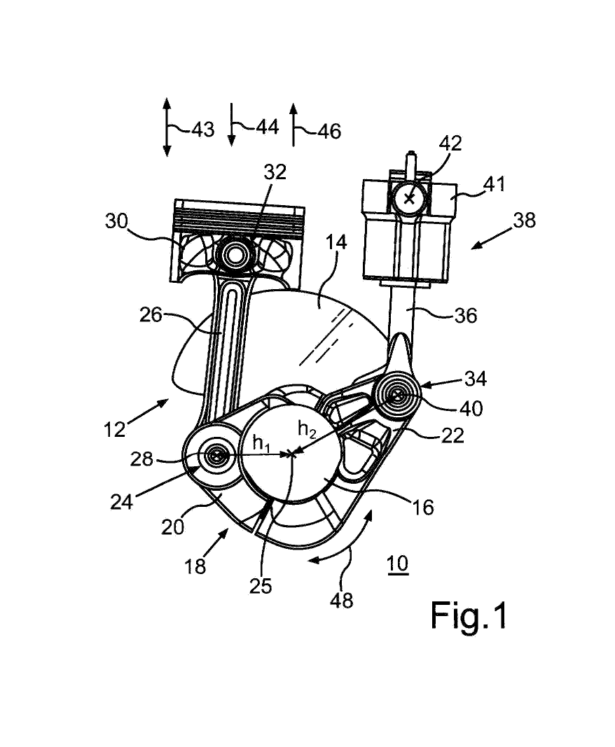

FIG. 1 shows a crank drive 10 for a reciprocating engine of a motor car, wherein the reciprocating engine comprises a plurality of cylinders. Due to the overview, using FIG. 1, the crank drive 10 is described in relation to one of these cylinders of the reciprocating engine corresponding to the crank drive 10. It is understood that the description relating to the crank drive 10 and the cylinder applies similarly to the other, in particular all the other, cylinders of the reciprocating engine.

The crank drive 10 comprises a crankshaft 12 comprising main bearing points, via which the crankshaft 12 is mounted in a crankcase of the reciprocating engine. The crankshaft 12 further comprises crank webs, one such crank web 14 being shown in FIG. 1. In addition the crankshaft 12 comprises crank pins, of which one crank pin 16 is shown in FIG. 1. The crank pin 16 corresponds to a cylinder of the reciprocating engine. In the same way the other crank pins also correspond to a respective cylinder of the reciprocating engine.

Furthermore the crank drive 10 comprises a transverse lever 18 which comprises a first lever arm 20 and a second lever arm 22 which are connected to each other, for example screwed to each other. The transverse lever 18 is mounted on the crank pin 16 for rotation about an axis of rotation 25 and carries out stroke movements upon rotation of the crankshaft 12, during operation of the reciprocating engine.

The transverse lever 18 comprises a first bearing point 24, on which a connecting rod 26 of the crank drive 10 is mounted in an articulated manner. The connecting rod 26 can thereby rotate about a rotation axis 28. As can be derived from FIG. 1, the rotation axis 28 is spaced apart from the rotation axis 25 in a radial direction of the crank pin 16 by a first lever arm length h₁.

The crank drive 10 also comprises a piston 30 which corresponds to the cylinder, to which the crank pin 16 corresponds and in which the piston 30 is received so that it can be moved in a translatory manner. The piston 30 is connected in an articulated manner to the connecting rod 26 via a further bearing point 32. The piston 30 is fixed to the connecting rod 26 via a piston pin which is secured in the piston 30 by a corresponding securing ring in the axial direction of the piston pin. If the piston 30 is moved in a translatory manner due to combustion processes in the cylinder, this translatory movement is converted via the connecting rod 26, the transverse lever 18 and the crank pin 16 into a rotational movement of the crankshaft 12.

The transverse lever 18 comprises a further bearing point 34 at the lever arm 22 where a control piston 36 of an adjusting means 38 of the reciprocating engine is mounted and connected to the transverse lever 18 in an articulated manner. The control piston 36 can thereby pivot about a rotation axis 40 of the bearing point 34. The rotation axis 40 is spaced apart by a further lever length h₂ in the radial direction of the crank pin 16 from the rotation axis 25. It can be seen that the lever lengths h₁ and h₂ differ from each other. The length h₂ of the lever h₂ is larger than the length h₁ of the lever 20. It is also possible for the lever lengths h₁ and h₂ to be the same or for the lever length h₁ to be larger than the lever length h₂. In addition to the control piston 36 the adjusting means 38 comprises a housing 41 forming a cylinder. The control piston 36 is held in the cylinder so that it can be guided in a translatory movement. By supplying or removing a work medium to/from the cylinder, for example compressed air, hydraulic liquid or similar, the control piston 36 can be moved in a translatory manner according to a direction arrow 43 and moved out in relation to the housing 41 according to a direction arrow 44 or moved according to a direction arrow 46. In contrast with such an active adjustment, a passive adjustment is also possible, wherein the control piston 36 is moved due to gas and mass forces of the reciprocating engine which act via the piston 30 on the control piston 36. The control piston 36 is released in a desired movement direction and blocked or held securely in a movement direction opposing the desired movement direction through the work medium and valve means, for example non-return valves, which are connected via other control valves, for example a control slide valve with control edges which release or shut off lines for the work medium. It is thereby a type of hydraulic free-wheeling. This embodiment has the advantage that a desired compression ratio can be set without, or only with very limited, additional energy resources. It is also possible to actuate the control piston 36 by means of an electromagnet.

When the crankshaft 12 rotates, the crank pin 16 moves up and down, whereby this also leads to a movement of the transverse lever 18. The adjusting means 38 also moves in that the housing 41 is mounted pivotally about a pivot axis 42 on a housing surrounding the adjusting means 38, for example on a crankcase of the reciprocating engine.

If the control piston 36 is moved in a translatory manner according to the direction arrow 43, this leads to a rotation of the transverse lever 18 relative to the crank pin 16 according to a direction arrow 48, whereby the compression ratio of the corresponding cylinder can be set. The adjustment of the control piston 36 thereby acts via the ratio of the lever lengths h₁ and h₂ to the same extent, amplified or reduced. In other words the adjustment of the control piston 36 leads to an adjustment or displacement of top dead centre of the piston 30 in the cylinder and thus to a displacement or adjustment of the compression volume V_{c} of the corresponding cylinder. The adjustment of the control piston 36 also changes the stroke location and thus the compression ratio. The compression volume V_{c} is reduced in case of an increasing compression ratio, which is desirable in the sense of the downsizing concept. This results in a corresponding compression ratio which is also described as ε.

As already indicated, such an adjusting means 38 is advantageously assigned to each of the cylinders of the reciprocating engine, by means of which the compression ratio of the corresponding cylinder can be set independently of the other cylinders. This cylinder-specific setting of the corresponding compression ratios facilitates a very precise adaptation, essentially in accordance with requirements of the reciprocating engine to momentary operating points so that the reciprocating engine can be operated very efficiently with low emissions and low energy consumption, in particular low fuel consumption.

It is thereby desirable for the precise adjustment of the compression ratio in line with requirements to determine and possibly verify the adjusted compression ratio. This is possible for example in that the position of the control piston 36 relative to a reference point and/or the travel covered in the movement of the control piston 36, thus the setting of the control piston 36, is/are detected and on the basis thereof, inter alia, also in dependence upon the levers 20 and 22, the connecting rod 26, etc., conclusions can be drawn and determinations made concerning the adjusted compression ratio. A signal characterizing the position or stroke of the control piston 36 can be used to control or regulate the compression ratio in order to adjust this variably, continuously or in steps.

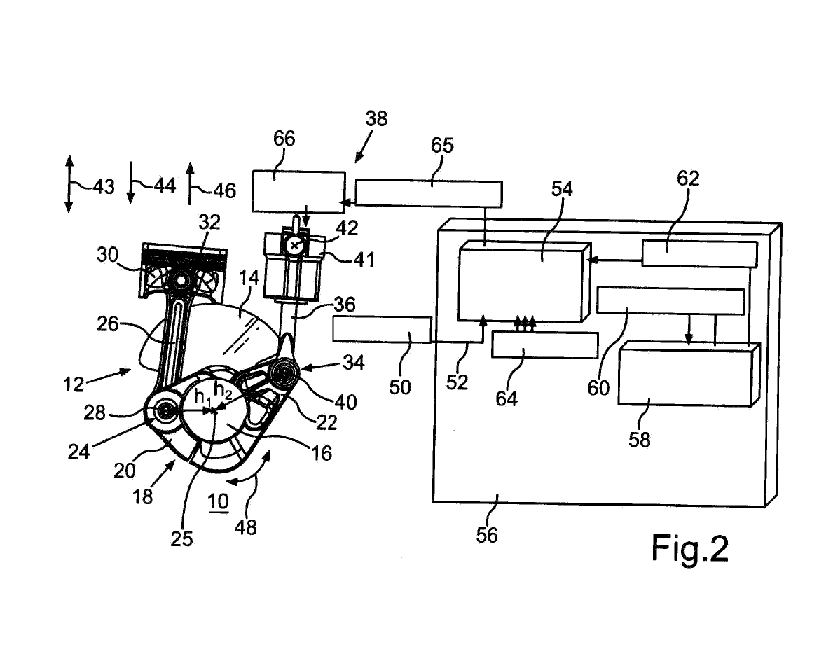

This is shown by using the sketch of the principle operation of FIG. 2. A sensor 50 shown schematically in FIG. 2 detects the position of the control piston 36 or a connecting rod thereof relative to a reference point and/or the stroke of the control piston 36 or a signal characterizing the position and/or the stroke. This signal is transmitted according to a direction arrow 52 to a position regulating unit 54 of a regulating means 56, wherein the regulating means 56 is configured for example as a control unit of the reciprocating engine. The regulating means 56 further comprises a combustion regulating unit 58, by means of which the combustion processes are controlled or regulated in the cylinders of the reciprocating engine. For this purpose, the combustion regulating unit 58 takes into consideration, inter alia, a feedback 60 of the adjusted actual compression ratio which is determined from the position regulating unit 54 using the signal detected by the sensor 50 and thus by reference to the position of the control piston 36. In order to adjust the compression ratio and to adapt it to an operating point of the reciprocating engine the combustion regulating unit 58 transmits a default value 62 of a reference compression ratio to the position regulating unit 54, which conveys the reference compression ratio into a position of the control piston 36 to be set. In this connection the position regulating unit 54 also takes into consideration any other system values 64 of the crank drive 10 and the reciprocating engine.

The determined position for adjusting the desired compression ratio or a signal characterizing the position of the control piston 36 is transmitted to a controller 65 for the control means 38 which transmits corresponding control signals to an actuator 66, by means of which the control piston 36 is moved and the compression ratio is thus adjusted.

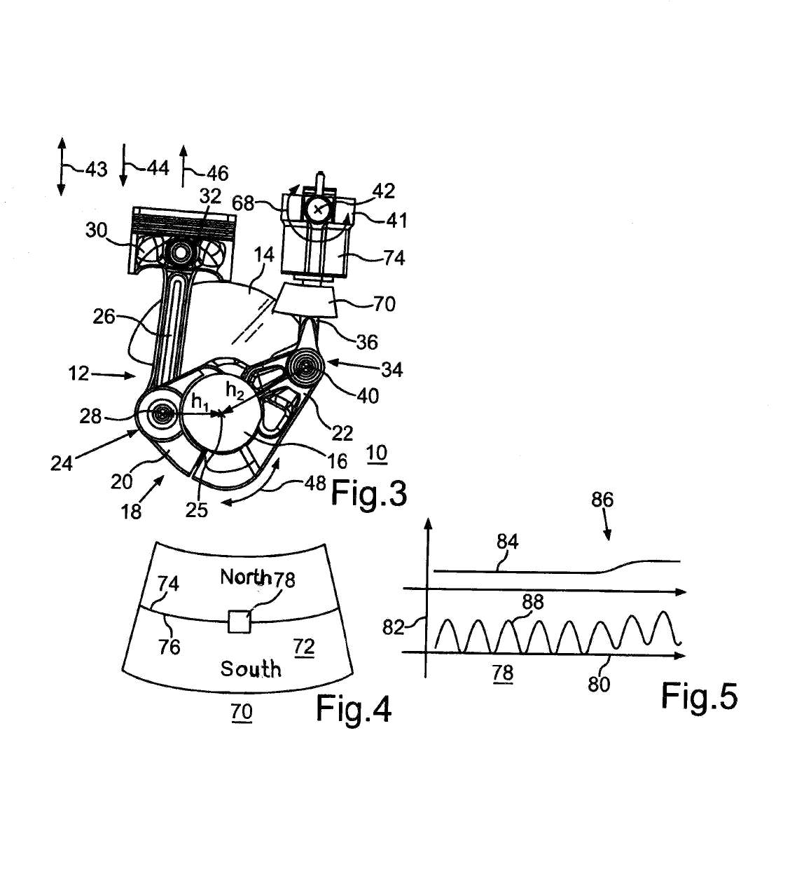

FIG. 3 shows a possibility of detecting the position of the control piston 36 in order to precisely determine and consequently precisely adjust the set compression ratio in dependence upon this position. In this connection the sensor 50 comprises a bipolar transducer plate 70 which is shown schematically in FIG. 4 and comprises a magnetic field 72. The transducer plate 70 is curved, in the same way as its magnetic field, wherein the center point of the curvature lies on the pivot axis 42. This causes the curvature of the transducer plate 70 and the magnetic field 72 to correspond to the pivot movement of the control piston 36 which the control piston 36 carries out during the operation of the reciprocating engine during pivoting about the pivot axis 42 according to a direction arrow 68.

The term “North” in FIG. 4 thereby describes the north pole of the magnetic field 72, while the term “South” in FIG. 4 describes the south pole of the magnetic field 72. A curved line 74 indicates a boundary between the north pole and the south pole and illustrates that the magnetic field 72 has a curved formation. A further line 76 in FIG. 4 indicates an imagined boundary of a non-curved but instead straight magnetic field of the emitter plate 70. A detection part 78 of the sensor 50 is also shown in FIG. 4, by means of which the magnetic field 72 is to detect the position of the control piston 36.

Using the orientation of the magnetic field 72, the sensor 50 detects via the detection part 78, the momentary position or the momentary stroke of the control piston 36 for setting the compression ratio, thus how far the control piston 36 has travelled out of or into the housing. This position characterises the compression ratio. If a certain compression ratio is retained the translatory position according to the direction arrow 43 of the control piston 36 also remains constant. Nonetheless the control piston 36 moves in rotation during the operation of the reciprocating engine in that the control piston 36 pivots about the pivot axis 42 according to the direction arrow 68 and thereby carries out a swing movement.

For precise detection of the translatory position of the control piston 36 also during this swing movement the transducer plate 70 and its magnetic field 72 are formed curved and have a correspondingly large extension in the movement direction of the control piston 36 for adjusting the compression ratio according to the direction arrow 43. It is thereby guaranteed that the detection part 78 constantly corresponds to the transducer plate 70, at least in areas, in particular predominantly and particularly preferably completely. The arc-form formation of the transducer plate 70 and of the magnetic field 72 avoids or reduces at least an angle error signal which in case of a straight magnetic field would be unequal, larger or not even be generated at all.

This is shown in FIG. 5. FIG. 5 shows a diagram 78, on the x-axis 80 of which the time is recorded and on the y-axis 82 of which a value characterizing the magnetic field 72 is indicated. A progression 84 in the diagram 78 indicates a behavior of a value characterizing the magnetic field 72 over a period shown in the diagram 78, in which the reciprocating engine is in operation and accordingly the control piston 36 swings about the pivot axis 42. As the magnetic field 72 is curved the value characterizing the magnetic field remains constant. Using the value characterizing the magnetic field 72 the correspondingly set compression ratio can be clearly determined. A change in the value characterizing the magnetic field 72, as indicated in the diagram 78 in a region 86, results merely from the control piston 36 being moved in a translatory manner according to the direction arrow 43 and the compression ratio thus being changed. The pivoting or the swing movement of the control piston 36 about the pivot axis 42 does not influence the value characterizing the magnetic field 72.

In contrast therewith, a further progression 88 is also shown in diagram 78 which reproduces the behavior of a value characterizing the magnetic field, which, in contrast with the magnetic field 72 and the line 76, is correspondingly straight and formed for example through a likewise straight transducer plate.

As can be seen using the progression 88, a swing movement corresponding to the swing movement of the control piston 36 about the pivot axis 42 results and represents a signal which is difficult to manage and provides little information for detecting the position of the control piston 36 for setting the compression ratio. The comparison of the progressions 84 and 88 shows that the position of the controt piston 36 for adjusting of the compression ratio, thus in a translatory direction according to the direction arrow 43, can be detected by the curved magnetic field 72 substantially more precisely and informatively.

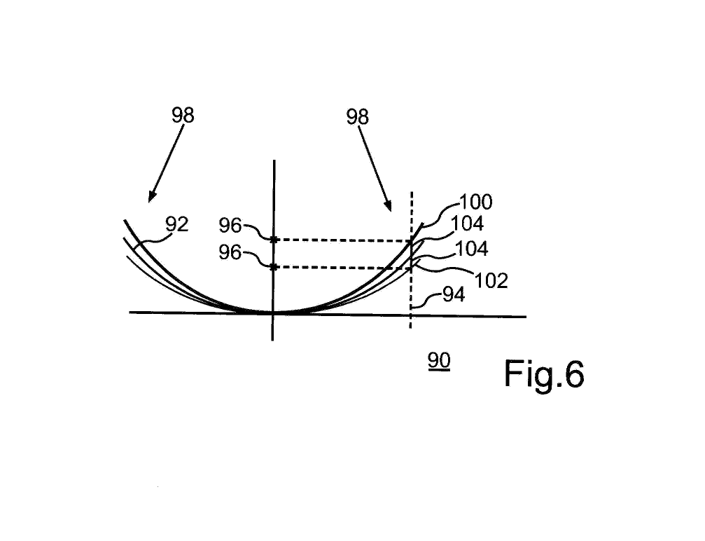

FIG. 6 shows a further possibility for particularly precisely and accurately detecting the position of the control piston 36 and thereby determining the set cornpression ratio particularly precisely. FIG. 6 shows a diagram 90, in which a progression 92 of a signal is shown, which characterizes the position of the control piston 36 detected by the transducer plate 70 and the magnetic field 72 with a set compression ratio and during the execution of the swing movement about the pivot axis 42 according to the direction arrow 68.

The signal characterizing the position is synchronized with a rotation position, detected by means of a further detection means, which is called a crank angle degree, of the crankshaft 12 of the reciprocating engine in order to compensate a deviation of the detected position of the control piston 36 from the actually present position.

FIG. 6 shows a detection time 94. At the detection time 94 there is a correspending position of the control piston 36 which is characterized by a value 96 characterizing the magnetic field 72. As can be deduced from FIG. 6, however, even when using the curved emitter plate 70 and the curved magnetic field 72, in particular in end regions 98 of a pivot range of the control piston 36, in which the control piston 36 can pivot during operation of the reciprocating engine, there is a deviation of the detected position from the actual position. This is the case in particular if the control piston 36 has travelled out to a maximum, whereby this is shown by a progression 100, or if the control piston 36 has travelled in to a maximum, whereby this is shown by a progression 102. In other words, the progression 100 constitutes a running path of the swing movement of the control piston 36 with its maximum stroke, thus when the control piston has travelled out to a maximum. The progression 102 constitutes, in other words, a running path of the swing movement of the control piston in case of a minimum stroke, thus when the control piston 36 has travelled in to a maximum. The progression 92 constitutes a nominal curve of the magnetic field 72. The deviation described is characterized in the diagram 90 by a measurement error 104.

Compensation for this deviation or this measurement error 104 can be carried out using a characteristic diagram stored in the regulating unit 56. As the rotation position of the crankshaft 12 clearly represents a position on the transducer plate 70, the error can be compensated in the current detection time 94 as the measurement errors 104 have been determined for example in trials and are stored in the characteristic diagram. The maximum measurement error 104 is dependent upon the deviation between the detected position of the control piston 36 and the assigned crank angle degree. The measurement error 104 is composed of a duration for signal generation in the sensor 50, a duration for signal transmission, a duration for signal processing in the regulating unit 56 and a duration of a calculation time which the regulating unit 56 requires for an assignment of the crank angle degree to the value 96.

### LISTING OF REFERENCE NUMERALS

10 Crank drive
12 Crankshaft
14 Crank cheek
16 Crank pin
18 Transverse lever
20 Lever arm
22 Lever arm
24 Bearing point
25 Rotation axis
26 Connecting rod
28 Rotation axis
30 Piston
32 Bearing point
34 Bearing point
36 Control piston
38 Adjusting means
40 Rotation axis
41 Housing
42 Pivot axis
43 Direction arrow
44 Direction arrow
46 Direction arrow
48 Direction arrow
50 Sensor
52 Direction arrow
54 Position regulating unit
56 Regulating unit
58 Combustion regulating unit
60 Feedback
62 Default value
64 System values
65 Control
66 Actuator
68 Direction arrow
70 Transducer plate
72 Magnetic field
74 Line
76 Line
78 Diagram
80 X-axis
82 Y-axis
84 Progression
86 Range
88 Progression
90 Diagram
92 Progression
94 Detection time
96 Value
98 Region
100 Progression
102 Progression
104 Measurement error
h₁ Lever length
h₂ Lever length

What is claimed is:

1. A reciprocating engine with variable compression ratio comprising at least one cylinder, a piston (30) movably received in the cylinder so as to be guided in a translatory movement, an adjusting means (28) including an adjusting part (36) supported on a guide element (41) of the adjusting means (38) including an adjusting part (36) supported on a guide element (41) of the adjusting means (38) so as to be movable between at least two positions for adjusting a compression ratio of the cylinder, the compression ratio being determined in dependence upon at least one signal provided by at least one detection means (50) characterizing the positions of the adjusting means (28),
the detection means (50) comprising a transducer part (70), and a corresponding detection part (78) in the form of a detection plate (78) wherein the transducer part (70) is arranged on one of the adjusting part (36) and a housing of the reciprocating engine where the adjusting part (36) and the guide element (41) are supported together pivotally about a pivot axis (42), the detection part (78) being correspondingly arranged on a housing of the reciprocating engine where the adjusting part (36) and the guide element (41) are supported together pivotally about a pivot axis (42), the detection part (78) being correspondingly arranged on a housing of the reciprocating engine, in which the adjusting part (36) and the guide element (41) are mounted.

2. The variable compression ratio engine according to claim 1, wherein at least one of the detection part (78) and the transducer part (70) is curved, in relation to the pivot axis (42).

3. The variable compression ratio engine according to claim 2, wherein a magnetic field (72) of the transducer part (70) is provided which is curved convexly relative to the pivot axis (42).

4. The variable compression ratio engine according to claim 1, wherein the detection means (50) is one of a Hall sensor and an optical detection means generating a position signal.

5. The variable compression ratio engine according to claim 4, wherein a position signal is synchronized with a rotational position of a crankshaft (12) of the reciprocating engine.

6. The variable compression ratio engine according to claim 4, wherein one of an analog and digital transmission path is provided for supplying the signal to a control unit (56) of the reciprocating engine.

7. The variable compression ratio engine according to claim 6, where the control unit (56) includes stored therein a characteristic diagram in which a deviation of the position of the adjusting part (36) determined on the basis of a signal from an actual position predetermined and recorded in a table, a corrected position signal is determined using the signal adapted at least substantially to the actual position of the adjusting part (36).

8. The variable compression ratio engine according to claim 7, wherein the control unit is provided for correcting the deviation in dependence upon a generation of the signal by the detection means (50) and/or a duration of a transmission of the signal to a control unit (56) of at least one of the reciprocating engine, a duration of signal processing and a calculating performance of a control unit (56) of the reciprocating engine.
